(19) United States
(12) Patent Application Publication
(10) Pub. No.: US 2026/0088000 A1
(43) Pub. Date: Mar. 26, 2026

(54) BACKLIGHT DEVICE, LIQUID CRYSTAL DISPLAY DEVICE, AND METHOD FOR CONTROLLING BACKLIGHT DEVICE

(71) Applicant: Nichia Corporation, Anan-shi (JP)

(72) Inventor: Kohei SUZAKI, Komatsushima-shi (JP)

(21) Appl. No.: 19/335,908

(22) Filed: Sep. 22, 2025

(30) Foreign Application Priority Data
Sep. 24, 2024 (JP) 2024-164998

(51) Int. Cl. G09G 3/34; G02F 1/1335; G09G 3/36

(52) U.S. Cl. CPC G09G 3/3426; G02F 1/133612; G09G 3/36; G09G 2320/0247; G09G 2320/0261; G09G 2320/064

(57) ABSTRACT

A backlight device configured to be disposed under a liquid crystal panel includes a plurality of light-emitting units, a backlight driving circuit, and a lighting stop circuit. Each of the plurality of light-emitting units includes one or more light sources. The backlight driving circuit is configured to generate a scan synchronization signal that is asynchronous to a vertical synchronization signal generated for each frame cycle of the liquid crystal display and generate a plurality of scan signals to sequentially turn on the plurality of light-emitting units in each cycle of the scan synchronization signal, in synchronization with the generated scan synchronization signal. The lighting stop circuit is configured to stop lighting of the plurality of light-emitting units periodically during one cycle or a plurality of cycles of the scan synchronization signal.

### CROSS-REFERENCE TO RELATED APPLICATION

This application claims priority to Japanese Patent Application No. 2024-164998 filed on September 24, 2024, the disclosure of which is hereby incorporated by reference in its entirety.

### BACKGROUND

### Technical Field

The present disclosure relates to a backlight device, a liquid crystal display device, and a method for controlling a backlight device.

### Background Art

There is known a method of reducing motion blur in video images displayed on a liquid crystal display device including a backlight device by intermittently turning on the backlight device in synchronization with a drive signal for driving a liquid crystal panel. In this case, by increasing the driving frequency of the backlight device and making the ratio of the lighting period to the driving cycle constant, flickering of the video images is reduced.

### SUMMARY

An object of the present disclosure is to reduce, in a backlight device and a liquid crystal display device including the backlight device, flickering of video images when motion blur is reduced by sequentially turning on a plurality of light-emitting units, using a synchronization signal asynchronous to a vertical synchronization signal for driving a liquid crystal panel.

A backlight device according to an embodiment of the present disclosure is a backlight device configured to be disposed under a liquid crystal panel, the backlight device includes a plurality of light-emitting units, a backlight driving circuit, and a lighting stop circuit. Each of the plurality of light-emitting units includes one or more light sources. The backlight driving circuit is configured to generate a scan synchronization signal that is asynchronous to a vertical synchronization signal generated for each frame cycle of the liquid crystal panel and generate a plurality of scan signals to sequentially turn on the plurality of light-emitting units in synchronization with the generated scan synchronization signal. The lighting stop circuit is configured to stop lighting of the plurality of light-emitting units during one or more cycles of the scan synchronization signal.

According to an embodiment of the present disclosure, in a backlight device and a liquid crystal display device including the backlight device, it is possible to reduce flickering of video images when motion blur is reduced by sequentially turning on a plurality of light-emitting units, using a synchronization signal asynchronous to a vertical synchronization signal for driving a liquid crystal panel.

### BRIEF DESCRIPTION OF DRAWINGS

FIG. 1 schematically illustrates an exploded perspective view of an example of a backlight device and a liquid crystal display device according to a first embodiment.

FIG. 2 illustrates a top view of an example of a planar light source of FIG. 1.

FIG. 3 illustrates a cross-sectional view of the example of the planar light source in a cross section taken along line III-III in FIG. 2.

FIG. 4A illustrates a top view of a modified example of the planar light source illustrated in FIG. 3.

FIG. 4B illustrates a cross-sectional view of the modified example of the planar light source in a cross section taken along line XIB-XIB in FIG. 4A.

FIG. 5 is a diagram illustrating an example of rectangular regions each including a plurality of light-emitting regions that simultaneously emit light in the backlight device of FIG. 1.

FIG. 6 is a block diagram illustrating an example of the liquid crystal display device of FIG. 1.

FIG. 7 is a circuit block diagram illustrating an example of the backlight device of FIG. 6.

FIG. 8 is a circuit block diagram illustrating an example of a cutoff control unit of FIG. 7.

FIG. 9 is a timing chart illustrating an example of operations of the liquid crystal display device of FIG. 1.

FIG. 10 is a timing chart illustrating another example of the operations of the liquid crystal display device of FIG. 1.

FIG. 11 is a waveform diagram illustrating an example of a current flowing through light-emitting elements when each rectangular region of the planar light source of FIG. 6 is scan-driven.

FIG. 12 is a timing chart illustrating a comparative example of operations of the liquid crystal display device in which a scan synchronization signal is generated asynchronously with a vertical synchronization signal and a cutoff signal is generated synchronously with the vertical synchronization signal.

FIG. 13 is a block diagram illustrating an example of a liquid crystal display device according to a second embodiment.

### DETAILED DESCRIPTION

Hereinafter, certain embodiments of the invention are described with reference to the drawings. In the following description, terms indicating specific directions or positions (e.g., "upper", "lower", and other terms including those terms) are used as necessary. Those terms are used to facilitate understanding of the invention with reference to the drawings, and the technical scope of the present invention is not limited by the meanings of those terms. In addition, parts having the same reference characters illustrated in a plurality of drawings indicate identical or equivalent parts or members.

Further, the following embodiments exemplify a liquid crystal display device, a backlight device, and the like for embodying a technical concept of the present invention, but the present invention is not limited to the description below. The dimensions, materials, shapes, relative arrangement, and the like of constituent components described below are not intended to limit the scope of the present invention to those alone, but are intended to provide an example, unless otherwise specified. The contents described in an embodiment can be applied to any of the other embodiments and a modified example. The sizes, the positional relationship, and the like of the members illustrated in the drawings may or may not be exaggerated in order to clarify the explanation. Furthermore, in order to avoid excessive complication of the drawings, a schematic view in which some elements are not illustrated may be used, or an end view illustrating only a cutting surface may be used as a cross-sectional view.

It is noted that in each of the drawings illustrating configurations, an X-axis, a Y-axis, and a Z-axis orthogonal to each other are illustrated for reference. Also, a direction parallel to the X-axis is referred to as an X direction, a direction parallel to the Y-axis is referred to as a Y direction, and a direction parallel to the Z-axis is referred to as a Z direction. In addition, in the X direction, a direction in which an arrow is directed is also referred to as a +X direction, and a direction opposite to the +X direction is also referred to as a -X direction. In the Y direction, a direction in which an arrow is directed is also referred to as a +Y direction, and a direction opposite to the +Y direction is also referred to as a -Y direction. In the Z direction, a direction in which an arrow is directed is also referred to as a +Z direction, and a direction opposite to the +Z direction is also referred to as a -Z direction.

In addition, a reference character indicating a signal may be used as a reference character indicating a signal line, a signal terminal, or a signal node. Reference characters indicating power source/voltage may be used as reference characters indicating a power source line/voltage line, a power source terminal/voltage terminal, and a power source node/voltage node.

### First Embodiment

### Backlight Device and Liquid Crystal Display Device

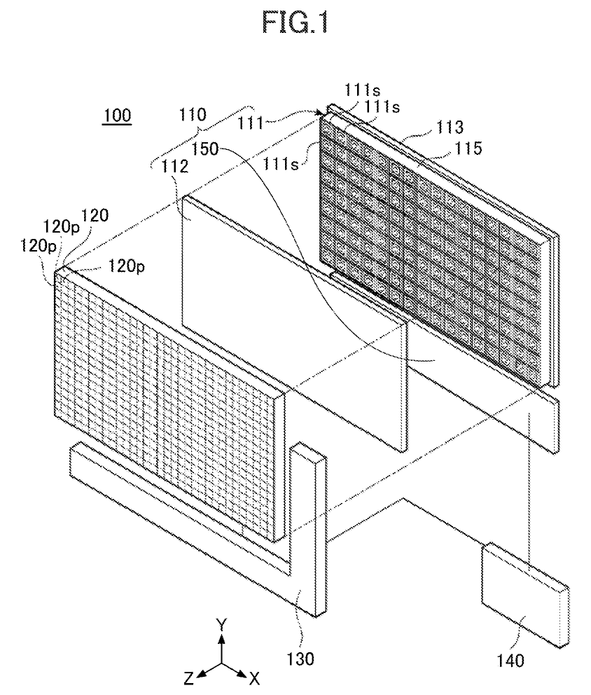

FIG. 1 schematically illustrates an exploded perspective view of an example of a backlight device and a liquid crystal display device according to a first embodiment. A liquid crystal display device 100 according to the present embodiment is, for example, a liquid crystal module (LCM) used for a display of an external device (not illustrated) such as a television, a personal computer, or a game machine. The liquid crystal display device 100 includes a backlight device 110, a liquid crystal panel 120, a liquid crystal driving circuit 130, and a control circuit 140.

The backlight device 110 includes a planar light source 111, an optical member 112 disposed on the liquid crystal panel 120 side of the planar light source 111, and a backlight driving circuit 150. The backlight driving circuit 150 may be provided outside the backlight device 110.

Each component of the liquid crystal display device 100 will be described below. In FIG. 1, in order to facilitate understanding, electrical connection between components is indicated by connecting the components to each other with a solid line. Components indicated by the solid lines connecting the components may include a plurality of signal lines and a plurality of power source lines.

The control circuit 140 outputs video data and control signals to the liquid crystal driving circuit 130 in order to display an image on the liquid crystal panel 120 for each frame, and displays the image on the liquid crystal panel 120. The control circuit 140 may output luminance-controlling information, indicating lighting operation of the planar light source 111, to the backlight driving circuit 150 based on video data for each frame transferred to the liquid crystal panel 120.

In the backlight device 110, the planar light source 111 includes a rectangular substrate 113, a light guide member 115 disposed above the substrate 113, and two-dimensionally arranged light-emitting regions 111s. The light guide member 115 has a plurality of recessed portions formed in a matrix. The light-emitting regions 111s are provided corresponding to light sources (not illustrated) disposed in the respective recessed portions. The backlight driving circuit 150 can emit light from one or the plurality of light-emitting regions 111s by driving the plurality of light sources two-dimensionally arranged in a matrix.

For example, the backlight device 110 may perform local dimming control by adjusting the luminance for every predetermined number of light-emitting regions 111s in accordance with an image displayed on the liquid crystal panel 120. By the local dimming control, the contrast ratio of an image can be improved and the power consumption of the backlight device 110 can be reduced.

The optical member 112 has, for example, a sheet shape or a plate shape, and has a light adjustment function of diffusing light of the backlight emitted from the light-emitting regions 111s toward the liquid crystal panel 120. In the present embodiment, the number of optical members 112 used in the backlight device 110 is one. Alternatively, the number of optical members used in the backlight device 110 may be two or more.

The liquid crystal panel 120 is disposed on the backlight device 110 (in the +Z direction) and has a rectangular shape. The liquid crystal panel 120 includes a plurality of pixels 120p arrayed in a matrix. In one example, each of the pixels 120p includes a sub-pixel that can transmit blue light, a sub-pixel that can transmit green light, and a sub-pixel that can transmit red light, to emit light of a desired color (e.g., white light) from the backlight device 110. The light transmittance of each sub-pixel can be individually controlled by the liquid crystal driving circuit 130. Thus, the liquid crystal panel 120 can display a color image by individually controlling the gradation level of each sub-pixel.

### Example of Planar Light Source

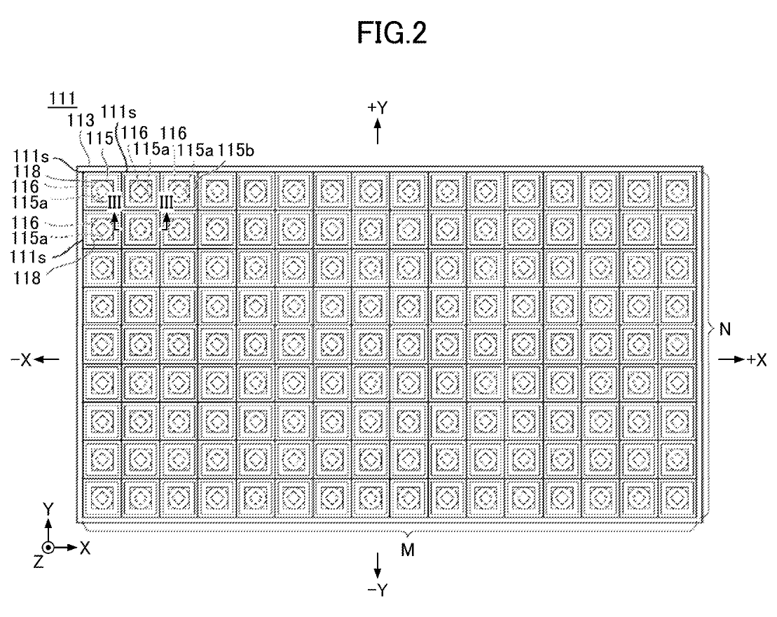

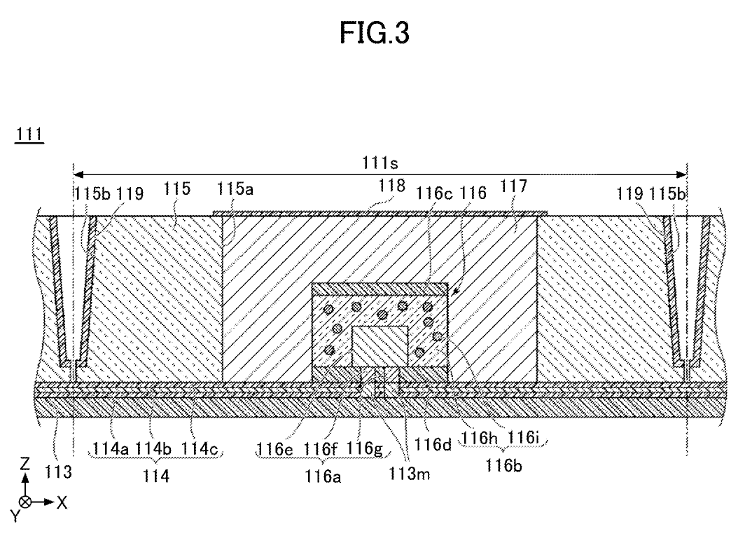

FIG. 2 illustrates a top view of an example of the planar light source 111 of FIG. 1. FIG. 3 illustrates a cross-sectional view of the example of the planar light source 111 in a cross section taken along line III-III in FIG. 2. The planar light source 111 includes a light-reflective sheet 114 formed on the substrate 113 illustrated in FIG. 1, the light guide member 115, a plurality of light sources 116, a light-transmissive member 117, a first light adjustment member 118, and a light-reflective member 119.

The substrate 113 is a wiring substrate including an insulating member and a plurality of wiring lines arranged on the insulating member. The upper and lower surfaces of the substrate 113 are flat and substantially parallel to the X direction and the Y direction (X-Y plane).

As illustrated in FIG. 3, the light-reflective sheet 114 is disposed on the substrate 113. The light-reflective sheet 114 includes, for example, a first adhesive layer 114a, a light-reflective layer 114b disposed on the first adhesive layer 114a, and a second adhesive layer 114c disposed on the light-reflective layer 114b. The light-reflective sheet 114 is adhered to the substrate 113 with the first adhesive layer 114a. For the light-reflective layer 114b, for example, a resin containing a large number of bubbles may be used.

The first adhesive layer 114a and the second adhesive layer 114c may contain, for example, a light-diffusing agent. In this case, the concentration of the light-diffusing agent contained in the second adhesive layer 114c is preferably lower than the concentration of the light-diffusing agent contained in the first adhesive layer 114a. This makes it possible to reduce unevenness in luminance in the light-emitting regions 111s to be described below. The light-diffusing agent used in the first adhesive layer 114a and the second adhesive layer 114c can be appropriately selected from, for example, light-diffusing agents used in a second light adjustment member 116c and a third light adjustment member 116d to be described below.

The light guide member 115 is disposed on the light-reflective sheet 114. The light guide member 115 is adhered to the light-reflective sheet 114 with the second adhesive layer 114c. For example, the shape of the light guide member 115 is a plate shape, but is not limited to the plate shape. The thickness of the light guide member 115 is preferably in a range from 200 μm to 800 μm. The light guide member 115 may be constituted by a single layer or may be constituted by a laminate body of a plurality of layers.

A material used for the light guide member 115 is, for example, a thermoplastic resin such as acrylic, polycarbonate, cyclic polyolefin, polyethylene terephthalate, or polyester, a thermosetting resin such as epoxy or silicone, or glass.

A plurality of light source arrangement portions 115a are provided in the light guide member 115. As illustrated in FIG. 2, the plurality of light source arrangement portions 115a are arrayed in a matrix in a top view. As illustrated in FIG. 3, each of the light source arrangement portions 115a is formed by a through hole penetrating the light guide member 115 in the Z direction. Alternatively, the light source arrangement portion 115a may be formed by the recessed portion provided on a lower surface of the light guide member 115.

Each of the light sources 116 is disposed within a corresponding one of the light source arrangement portions 115a. Therefore, as illustrated in FIG. 2, the plurality of light sources 116 are also two-dimensionally arranged in a matrix. Alternatively, when the light sources 116 are embedded in the light guide member 115, the light source arrangement portions 115a need not be provided in the light guide member 115. In addition, the light guide member 115 is not necessarily disposed in the planar light source 111. For example, the planar light source 111 may be such a light source in which the plurality of light sources 116 are simply two-dimensionally arranged in a matrix over a substrate without arranging the light guide member 115.

As illustrated in FIG. 3, each of the light sources 116 is a light-emitting device in which a light-emitting element 116a is combined with a wavelength conversion member 116b. Each of the light sources 116 further includes the second light adjustment member 116c and the third light adjustment member 116d. Alternatively, each of the light sources 116 may be a single light-emitting element instead of a light-emitting device.

The light-emitting element 116a is, for example, a light-emitting diode (LED). The light-emitting element 116a includes a semiconductor laminate body 116e and a pair of electrodes 116f and 116g electrically connecting the semiconductor laminate body 116e and the wiring line of the substrate 113. Through holes are provided in corresponding portions of the light-reflective sheet 114 located immediately below the electrodes 116f and 116g. In the through holes, conductive members 113m each electrically connecting a corresponding one of the electrodes 116f and 116g to the wiring line of the substrate 113 are disposed.

The wavelength conversion member 116b includes a light-transmissive member 116h that covers an upper surface and a side surface of the semiconductor laminate body 116e, and a wavelength conversion substance 116i that is disposed in the light-transmissive member 116h and converts the wavelength of light emitted from the semiconductor laminate body 116e into a different wavelength. The wavelength conversion substance 116i is, for example, a phosphor.

The light-emitting element 116a emits blue light, for example. In this case, the wavelength conversion member 116b may include a phosphor that emits red light and a phosphor that emits green light. Hereinafter, a phosphor that emits red light is referred to as a "red phosphor", and a phosphor that emits green light is referred to as a "green phosphor".

The red phosphor is, for example, a CASN-based phosphor (e.g., CaAlSiN₃: Eu), a KSF-based phosphor (e.g., K₂SiF₆: Mn), a KSAF-based phosphor (e.g., K₂[SiₚAl_{q}MnᵣFₛ](0.9 ≤ p + q + r ≤ 1.1, 0 < q ≤ 0.1, 0 < r ≤ 0.2, 5.9 ≤ s ≤ 6.1)), or a quantum dot phosphor (e.g., AgₚCu₁₋ₚIn_{q}Ga_{1-q}S₂(0 < p ≤ 1, 0 < q ≤ 1)).

In addition, the green phosphor is, for example, a phosphor having a perovskite structure (e.g., CsPb (F, Cl, Br, I)₃), a β-sialon-based phosphor (e.g., (Si, Al)₃(O, N)₄: Eu), a LAG-based phosphor (e.g., Lu₃ (Al, Ga)₅O₁₂: Ce), or a quantum dot phosphor (e.g., AgInₚGa₁₋ₚS₂(0 < p ≤ 1)).

The backlight device 110 can emit white light, which is mixed-color light of blue light emitted by the light-emitting element 116a and red light and green light emitted by the wavelength conversion member 116b.

Alternatively, the wavelength conversion member 116b may be replaced with a light-transmissive member that does not contain a phosphor. In this case, or when the light source 116 is the light-emitting element 116a alone as described above, for example, a phosphor sheet containing a red phosphor and a green phosphor may be disposed on the planar light source 111, or a phosphor sheet containing a red phosphor and a phosphor sheet containing a green phosphor may be disposed on the planar light source 111. As a result, the backlight device 110 can emit white light as in the case in which the wavelength conversion member 116b is used.

The second light adjustment member 116c is provided covering an upper surface of the wavelength conversion member 116b. The second light adjustment member 116c can control the amount and the emission direction of light emitted from the upper surface of the wavelength conversion member 116b.

The third light adjustment member 116d is provided covering the lower surface of the light-emitting element 116a and the lower surface of the wavelength conversion member 116b such that the lower surfaces of the electrodes 116f and 116g are exposed. The third light adjustment member 116d can reflect the light traveling toward the lower surface of the wavelength conversion member 116b to perform control such that the light exits from the upper surface and the side surface of the wavelength conversion member 116b.

The second light adjustment member 116c and the third light adjustment member 116d each can be formed of a light-transmissive resin and a light-diffusing agent included in the light-transmissive resin. The light-transmissive resin is, for example, a silicone resin, an epoxy resin, an acrylic resin, or the like. The light-diffusing agent is particles of titania, silica, alumina, zinc oxide, magnesium oxide, zirconia, yttria, calcium fluoride, magnesium fluoride, niobium pentoxide, barium titanate, tantalum pentoxide, barium sulfate, glass, or the like, for example. For example, a metallic member such as aluminum or silver may be used for the second light adjustment member 116c so that the luminance directly above the light source 116 does not become too high.

In the light source arrangement portion 115a, the light-transmissive member 117 is disposed covering the light source 116. The first light adjustment member 118 is disposed on the light-transmissive member 117. The first light adjustment member 118 can reflect part of the light incident from the light-transmissive member 117 and transmit the other part of the light so that the luminance immediately above the light source 116 does not become too high. The first light adjustment member 118 is preferably disposed so as to cover the interface between the light-transmissive member 117 and the light guide member 115 in a top view. Thus, it is possible to suppress a partial increase in luminance due to scattering of light from the light source 116 at the interface between the light-transmissive member 117 and the light guide member 115. A member similar to the second light adjustment member 116c or the third light adjustment member 116d can be used for the first light adjustment member 118.

Further, a partition groove 115b is provided in the light guide member 115, surrounding each of the light source arrangement portions 115a in a top view. The partition groove 115b extends in a lattice shape in the X direction and the Y direction. The partition groove 115b penetrates the light guide member 115 in the Z direction. The partition groove 115b may be a recessed portion provided on an upper surface or a lower surface of the light guide member 115. Further, the partition groove 115b need not be provided in the light guide member 115.

The light-reflective member 119 is disposed in the partition groove 115b. As the light-reflective member 119, for example, a member similar to the second light adjustment member 116c or the third light adjustment member 116d can be used. The light-reflective member 119 covers, in a layer shape, a part of the side surface of the partition groove 115b. The light-reflective member 119 may be extended so as to further cover the light-reflective sheet 114 exposed in the partition groove 115b, particularly, the upper surface of the second adhesive layer 114c such that the light from the light source 116 can be partitioned for each of the light-emitting regions 111s to be described below. The light-reflective member 119 may be disposed so as to fill the entire inside of the partition groove 115b. The light-reflective member 119 need not be disposed in the partition groove 115b.

The outputs of the plurality of light sources 116 can be individually controlled by the backlight driving circuit 150 (FIG. 1). Here, "output can be controlled" means that switching between turn-on and turn-off can be performed and that luminance in a turn-on state can be adjusted. The light-emitting regions 111s are regions obtained by dividing the planar light source 111 into regions each including the light source 116 in which a light output is individually controlled in a top view of FIG. 2. The light-emitting regions 111s each correspond to a minimum region in which luminance is adjusted by local dimming control in the planar light source 111.

For example, in the present embodiment, each of the light-emitting regions 111s corresponds to each region in a case in which the planar light source 111 is partitioned in a lattice shape, similarly to the partition grooves 115b. Therefore, the shape of each of the light-emitting regions 111s is rectangular as illustrated in FIG. 2. One of the light sources 116 is disposed in a corresponding one of the light-emitting regions 111s. Alternatively, in the planar light source 111, a plurality of light source groups each including the plurality of light sources 116 may be two-dimensionally arranged in a matrix, and the output may be controlled for each light source group. In this case, one light source group, that is, the plurality of light sources 116 are arranged in one of the light-emitting regions 111s.

The plurality of light-emitting regions 111s are two-dimensionally arranged in a matrix in a top view. Hereinafter, in a matrix structure like the plurality of light-emitting regions 111s, a group of elements such as the light-emitting regions 111s arranged in the X direction is referred to as a "row", and a group of elements such as the light-emitting regions 111s arranged in the Y direction is referred to as a "column". In addition, a row positioned on the side furthest in the +Y direction (the upper side of the liquid crystal display device 100 in FIG. 1) is referred to as a "first row", and a row positioned on the side furthest in the -Y direction (the lower side of the liquid crystal display device 100 in FIG. 1) is referred to as a "last row". Similarly, a column positioned on the side furthest in the -X direction (the left side of the liquid crystal display device 100 in FIG. 1) is referred to as a "first column", and a column positioned on the side furthest in the +X direction (the right side of the liquid crystal display device 100 in FIG. 1) is referred to as a "last column". The plurality of light-emitting regions 111s are arrayed in N rows and M columns. Here, N and M are given integers, and in the example illustrated in FIG. 2, "N" is 9 and "M" is 16.

### Modified Example of Planar Light Source

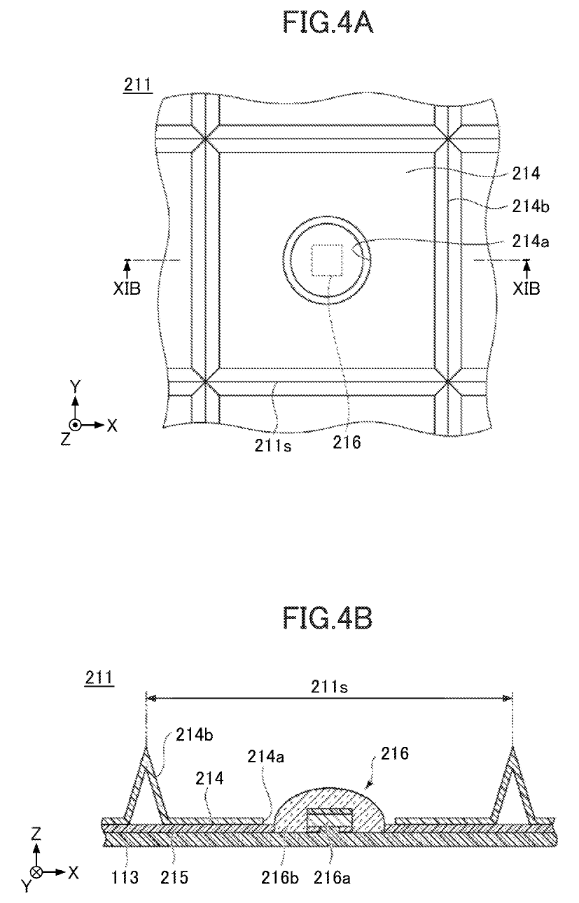

FIG. 4A illustrates a top view of a modified example of the planar light source 111 illustrated in FIG. 3. FIG. 4B illustrates a cross-sectional view of the modified example of the planar light source 111 in a cross section taken along line XIB-XIB in FIG. 4A. It is noted that differences from the above description will be mainly described below. Contents not described are the same as those described above.

A planar light source 211 illustrated in FIGS. 4A and 4B includes the substrate 113, an adhesive member 215, a light-reflective sheet 214, and a plurality of light sources 216. For example, the planar light source 211 is mounted in the backlight device 110, instead of the planar light source 111 illustrated in FIGS. 1 and 2.

The light-reflective sheet 214 is adhered to the substrate 113 with the adhesive member 215. The light-reflective sheet 214 is provided with a plurality of through holes 214a. The plurality of through holes 214a are arrayed in a matrix along the X direction and the Y direction. The light sources 216 are disposed in the respective through holes 214a. The light sources 216 correspond to the light sources 116 of FIGS. 2 and 3, and are two-dimensionally arranged in a matrix in the planar light source 211.

The light-reflective sheet 214 is provided with a bent portion 214b surrounding a corresponding one of the through holes 214a, i.e., a corresponding one of the light sources 216. The bent portion 214b is formed by folding the light-reflective sheet 214 such that the light-reflective sheet 214 protrudes in the Z direction. In the planar light source 211, one region surrounded by the top portion of the bent portion 214b in the Z direction corresponds to one light-emitting region 211s. The light-emitting region 211s is a region corresponding to the light-emitting region 111s of FIG. 2.

The light-reflective sheet 214 is formed using a resin sheet containing a large number of bubbles (for example, a foamed resin sheet), a resin sheet including a light-diffusing material, or the like. The resin used for the light-reflective sheet 214 is, for example, a thermoplastic resin such as an acrylic resin, a polycarbonate resin, a cyclic polyolefin resin, a polyethylene terephthalate resin, or a polyester resin, or a thermosetting resin such as an epoxy resin or a silicone resin. Further, the light-diffusing material used for the light-reflective sheet 214 is titanium oxide, silica, alumina, zinc oxide, glass, or the like.

Each of the light sources 216 includes a light-emitting element 216a and a wavelength conversion member 216b. The light-emitting element 216a is electrically connected to the substrate 113. The wavelength conversion member 216b is provided covering a lateral surface and an upper surface of the light-emitting element 216a. It is noted that the planar light sources 111 and 211 are not limited to the structures illustrated in FIGS. 3, 4A and 4B, as long as the light-emitting regions are two-dimensionally arranged in a matrix.

### Light-Emitting Region of Backlight Device

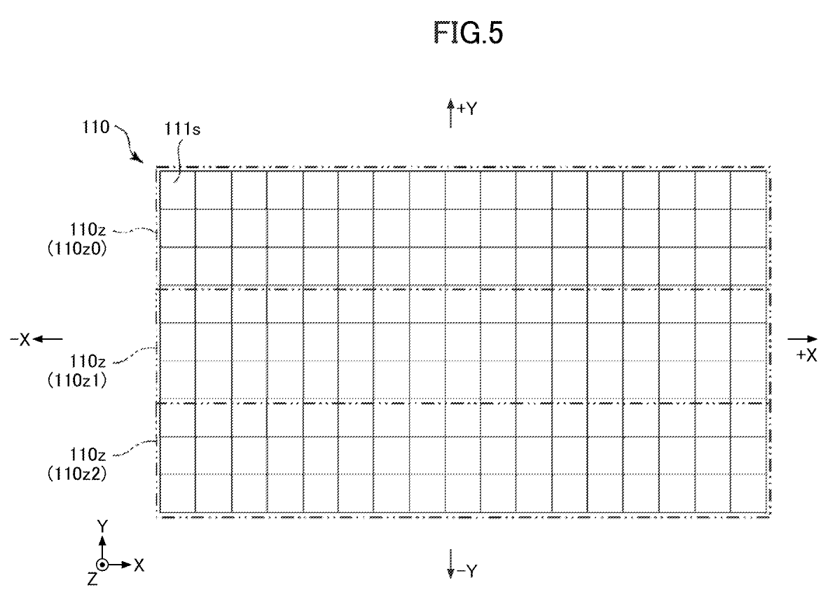

FIG. 5 is a diagram illustrating an example of rectangular regions each including the plurality of light-emitting regions 111s that simultaneously emit light in the backlight device 110 of FIG. 1. For example, the backlight device 110 is divided into three rectangular regions 110z0, 110z1, and 110z2 arrayed in the Y direction. Hereinafter, when the rectangular regions 110z0, 110z1, and 110z2 are described without distinction, they are also referred to as a rectangular region 110z. The backlight driving circuit 150 in FIG. 1 controls the light emission of the light sources 116 for each rectangular region 110z. Each rectangular region 110z is an example of a light-emitting unit.

Each rectangular region 110z includes at least one row of light-emitting regions 111s. In the example illustrated in FIG. 5, the backlight device 110 is divided into three rectangular regions 110z, and each rectangular region 110z includes three rows of light-emitting regions 111s arranged in a plane. Hereinafter, among the three rectangular regions 110z, the rectangular region 110z positioned on the side furthest in the +Y direction is also referred to as an "upper region 110z0". The rectangular region 110z positioned on the -Y side of the upper region 110z0 is also referred to as a "middle region 110z1". The rectangular region 110z positioned on the -Y side of the middle region 110z1 is also referred to as a "lower region 110z2".

It is noted that FIG. 5 illustrates an example in which each rectangular region 110z includes the plurality of light-emitting regions 111s of the planar light source 111 illustrated in FIG. 2. Alternatively, a light guide plate may be disposed in each of the three rectangular regions 110z, and an edge light-type LED module may be disposed as a light source at one end of each light guide plate in the X direction. In this case, the backlight driving circuit 150 performs scan driving to sequentially turn on the three LED modules. The three light guide plates respectively corresponding to the three LED modules each function as a light-emitting unit that emits light from a corresponding one of the LED modules toward the liquid crystal panel 120.

It is noted that the number of rectangular regions 110z in the backlight device 110 and the number and the number of rows of light-emitting regions 111s included in each of the rectangular regions 110z are not limited to the above-described numbers. For example, the number of rectangular regions 110z in the backlight device 110 may be four or more, and the number of rows of the light-emitting regions 111s included in each of the rectangular regions 110z may be one or more. Further, the plurality of rows of the light-emitting regions 111s included in each of the rectangular regions 110z may not only be collectively arranged as illustrated in FIG. 5 but also be dispersedly arranged in the Y direction. For example, when the end row in the +Y direction is the first row and the end row in the -Y direction is the ninth row, the rectangular region 110z0 may be disposed in the first, fourth, and seventh rows, the rectangular region 110z1 may be disposed in the second, fifth, and eighth rows, and the rectangular region 110z2 may be disposed in the third, sixth, and ninth rows. In addition, the rectangular regions 110z0 to 110z2 each may be arranged dispersedly in the Y direction not only by one row but also by a plurality of rows.

Further, for example, all the light-emitting regions 111s each may be the rectangular region, and lighting may be controlled independently for each of the light-emitting regions 111s. However, as the number of rectangular regions increases, a larger number of wiring lines are required, and the circuit scale of the backlight driving circuit 150, peripheral circuits of the backlight driving circuit 150, and the like increases with the increase in the number of wiring lines.

### Block Diagram of Liquid Crystal Display Device

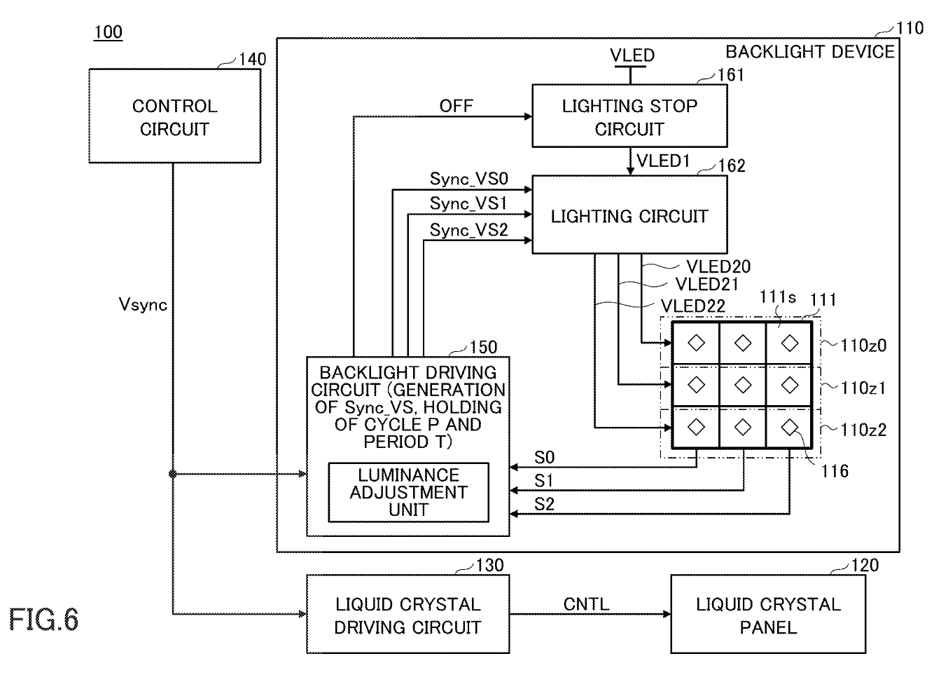

FIG. 6 is a block diagram illustrating an example of the liquid crystal display device 100 of FIG. 1. In FIG. 6 and subsequent figures, data lines for transmitting video data for displaying a video image on the liquid crystal panel 120 are not illustrated, and signal lines for transmitting various control signals and power source lines for supplying various voltages are illustrated as solid lines. The direction of the arrows of the signal lines indicates the direction in which signals are transmitted, and the direction of the arrows of the power source lines indicates the direction in which a current flows.

As illustrated in FIG. 1, the liquid crystal display device 100 includes the backlight device 110, the liquid crystal panel 120, the liquid crystal driving circuit 130, and the control circuit 140. The backlight device 110 includes the planar light source 111, the backlight driving circuit 150, a lighting stop circuit 161, and a lighting circuit 162. The lighting stop circuit 161 and the lighting circuit 162 are peripheral circuits of the backlight driving circuit 150, and are attached to the substrate 113 in FIG. 3, for example. The lighting stop circuit 161 may be included in the backlight driving circuit 150, or both the lighting stop circuit 161 and the lighting circuit 162 may be included in the backlight driving circuit 150.

FIG. 6 illustrates an example in which each of the upper region 110z0, the middle region 110z1, and the lower region 110z2 of the planar light source 111 includes three light-emitting regions 111s arrayed in the lateral direction (e.g., the X direction in FIG. 5), for simplicity of description. That is, each of the upper region 110z0, the middle region 110z1, and the lower region 110z2 includes three light sources 116 arrayed in the lateral direction. In FIG. 6, the optical member 112 disposed between the planar light source 111 and the liquid crystal panel 120 is not illustrated.

When operating the liquid crystal panel 120, the control circuit 140 outputs a vertical synchronization signal Vsync, which is a synchronization signal for determining one frame period of the liquid crystal panel 120, for one frame cycle. The vertical synchronization signal Vsync is also supplied to the backlight driving circuit 150. Although not illustrated, a control signal or the like other than the vertical synchronization signal Vsync may be output from the control circuit 140 to the liquid crystal driving circuit 130 and/or the backlight device 110. In this case, the control circuit 140 may be connected to the liquid crystal driving circuit 130 and/or the backlight device 110 via a serial interface such as a serial peripheral interface (SPI) that transmits a plurality of control signals.

The backlight driving circuit 150 generates a scan synchronization signal Sync_VS asynchronously with respect to the vertical synchronization signal Vsync. The backlight driving circuit 150 generates a scan signal Sync_VS0 for controlling lighting of the light sources 116 in the upper region 110z0 in synchronization with the scan synchronization signal Sync_VS, and outputs the generated scan signal Sync_VS0 to the lighting circuit 162. As described above, the scan synchronization signal Sync_VS is a synchronization signal that is generated asynchronously with respect to the vertical synchronization signal Vsync and is used to control the turning on and off of the light sources 116 of the planar light source 111.

The backlight driving circuit 150 generates a scan signal Sync_VS1 for controlling lighting of the light sources 116 in the middle region 110z1 in synchronization with the scan synchronization signal Sync_VS, and outputs the generated scan signal Sync_VS1 to the lighting circuit 162. The backlight driving circuit 150 generates a scan signal Sync_VS2 for controlling lighting of the light sources 116 in the lower region 110z2 in synchronization with the scan synchronization signal Sync_VS, and outputs the generated scan signal Sync_VS2 to the lighting circuit 162. Hereinafter, when the scan signals Sync_VS0, Sync_VS1, and Sync_VS2 are described without distinction, they are also referred to as a scan signal Sync_VSi.

In addition, the backlight driving circuit 150 outputs a cutoff signal OFF for stopping lighting of the light sources 116 in all of the rectangular regions 110z of the planar light source 111, to the lighting stop circuit 161. The backlight driving circuit 150 stores a value indicating a period P for outputting the cutoff signal OFF and a value indicating a time duration T for outputting the cutoff signal OFF. Then, in synchronization with the scan synchronization signal Sync_VS, the backlight driving circuit 150 generates the cutoff signal OFF having an output cycle indicated by the period P and an output period indicated by the time duration T.

Further, the backlight driving circuit 150 controls the voltage of a source line S0 connected to the light sources 116 in the first column (leftmost column) of the planar light source 111. The backlight driving circuit 150 controls the voltage of a source line S1 connected to the light sources 116 in the second column (central column) of the planar light source 111. The backlight driving circuit 150 controls the voltage of a source line S2 connected to the light sources 116 in the last column (rightmost column) of the planar light source 111. The source lines S0, S1, and S2 function as power source lines connected to a low level line set to a low level through the backlight driving circuit 150. The voltage of the low level line may be 0 V or a voltage slightly higher than 0 V (e.g., a voltage in a range from 0.1 V to 0.5 V).

The backlight driving circuit 150 may receive the vertical synchronization signal Vsync generated for each frame of the liquid crystal panel 120 and luminosity information (not illustrated) indicating a distribution of luminosity of an image to be displayed on the liquid crystal panel 120. The backlight driving circuit 150 may include, for example, a luminance adjustment unit (e.g., a luminance adjustment circuit) that adjusts the luminance in synchronization with the vertical synchronization signal Vsync for every predetermined number of light-emitting regions 111s or every rectangular region 110z in accordance with the image for each frame to be displayed on the liquid crystal panel 120.

Accordingly, the backlight driving circuit 150 can perform local dimming control even when turning on the light sources 116 in the upper region 110z0, the middle region 110z1, and the lower region 110z2 without synchronization with the vertical synchronization signal Vsync. The vertical synchronization signal Vsync is a synchronization signal used for control of outputting video data to the liquid crystal panel 120 for each frame and control of the luminance of the light source 116 of the planar light source 111 according to the video data for each frame.

The lighting stop circuit 161 cuts off the connection between a power source line VLED, which is a current source, and a power source line VLED1 while receiving the cutoff signal OFF at an active level (for example, a low level) from a cutoff control unit 153. The lighting stop circuit 161 connects the power source line VLED to the power source line VLED1 while receiving the cutoff signal OFF at an inactive level (for example, a high level) from the cutoff control unit 153. The power source line VLED is a current source for the planar light source 111.

Then, for example, every time a predetermined number of scan synchronization signals Sync_VS are generated, the lighting stop circuit 161 stops lighting of all of the rectangular regions 110z of the planar light source 111 during one or more cycles of the scan synchronization signals Sync_VS. The number of the plurality of cycles during which lighting of all the rectangular regions 110z is stopped is smaller than the predetermined number of cycles of the scan synchronization signals Sync_VS. Therefore, for every predetermined number of generations of scan synchronization signals Sync_VS, the rectangular regions 110z are turned off during one or more cycles, and are turned on during the predetermined number of remaining cycles.

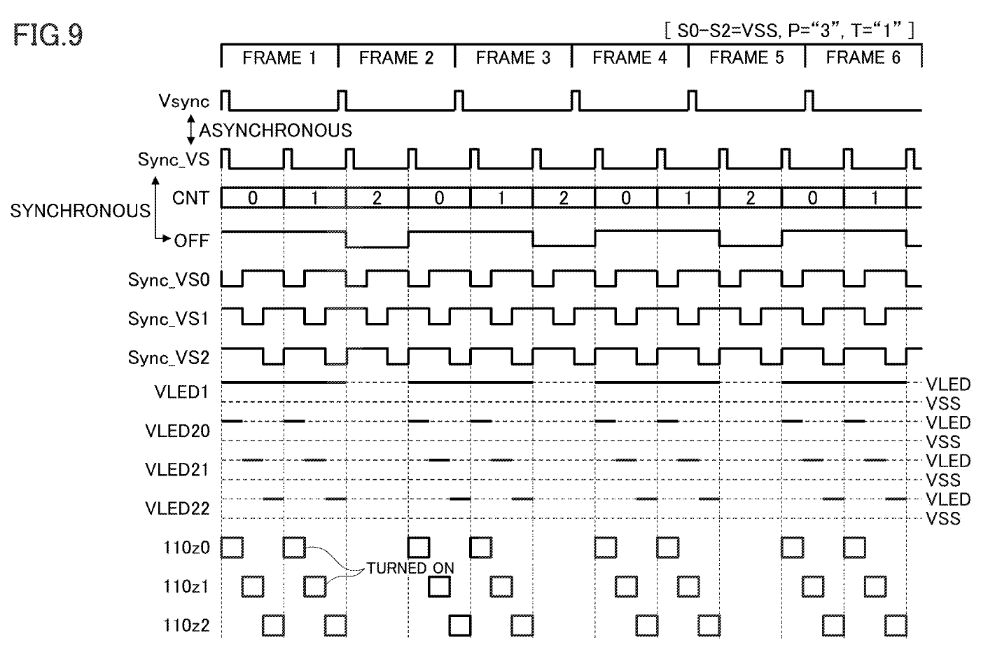

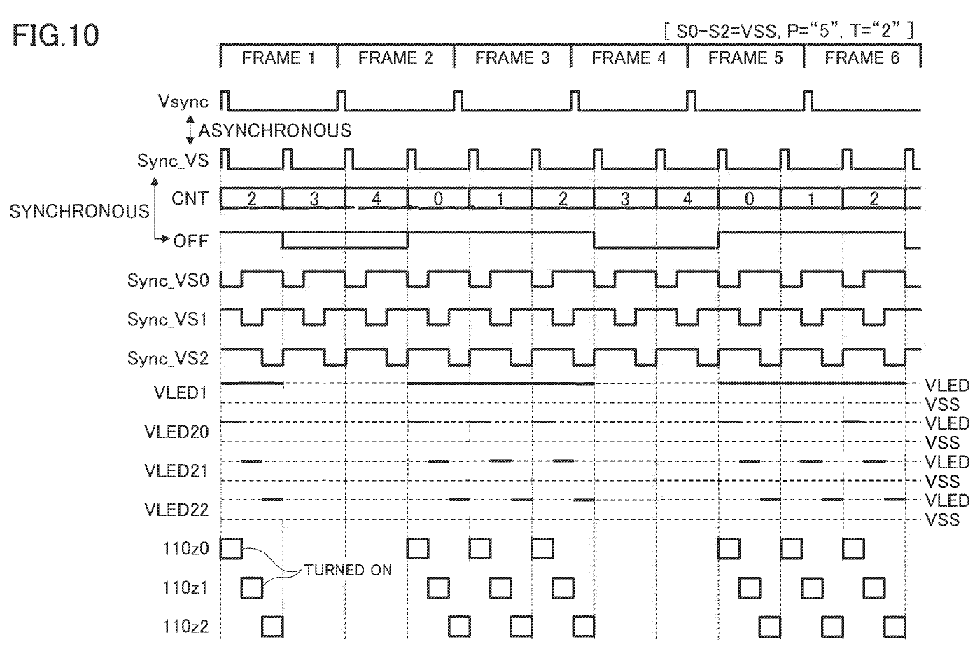

The operation of stopping lighting of all the rectangular regions 110z by the cutoff signal OFF will be described with reference to FIGS. 9 and 10.

The lighting circuit 162 connects the power source line VLED1 to a power source line VLED20 while receiving the scan signal Sync_VS0 at the active level, and disconnects the power source line VLED1 from the power source line VLED20 while receiving the scan signal Sync_VS0 at the inactive level. The power source line VLED20 is connected to the light sources 116 in the upper region 110z0.

The lighting circuit 162 connects the power source line VLED1 to a power source line VLED21 while receiving the scan signal Sync_VS1 at the active level, and disconnects the power source line VLED1 from the power source line VLED21 while receiving the scan signal Sync_VS1 at the inactive level. The power source line VLED21 is connected to the light sources 116 in the middle region 110z1.

The lighting circuit 162 connects the power source line VLED1 to a power source line VLED22 while receiving the scan signal Sync_VS2 at the active level, and disconnects the power source line VLED1 from the power source line VLED22 while receiving the scan signal Sync_VS2 at the inactive level. The power source line VLED22 is connected to the light sources 116 included in the lower region 110z2. For example, the active level of the scan signal Sync_VSi is a low level, and the inactive level of the scan signal Sync_VSi is a high level.

The liquid crystal driving circuit 130 outputs various control signals CNTL to the liquid crystal panel 120 every time the vertical synchronization signal Vsync is received from the control circuit 140, and causes the liquid crystal panel 120 to display an image of one frame in synchronization with the vertical synchronization signal Vsync.

### Circuit Block Diagram of Backlight Device

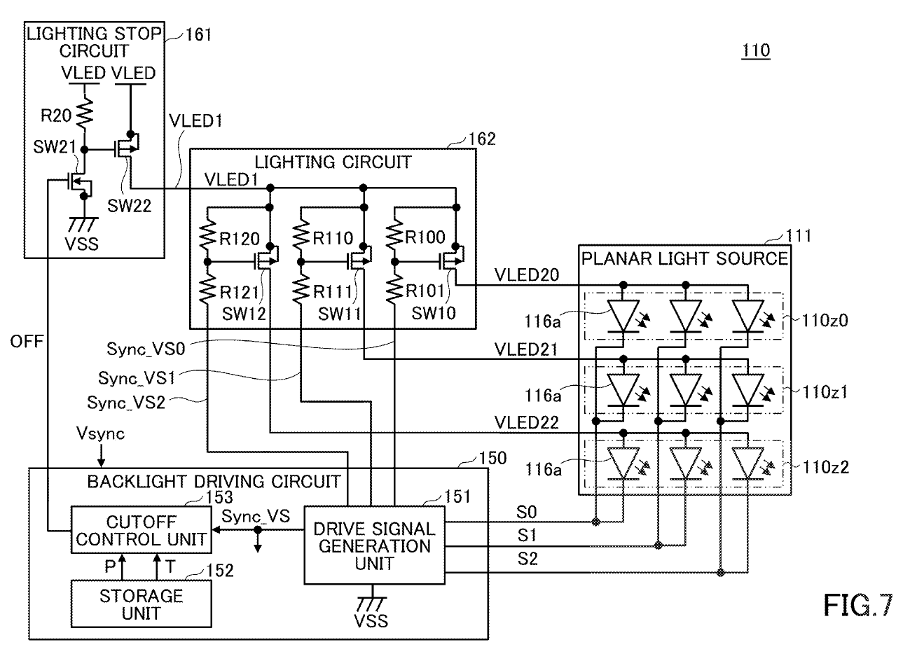

FIG. 7 is a circuit block diagram illustrating an example of the backlight device 110 of FIG. 6. In the following description, it is assumed that the light-emitting element 116a included in each of the light sources 116 of the planar light source 111 in FIG. 6 is an LED.

In the planar light source 111, the anodes of the three light-emitting elements 116a in the upper region 110z0 are connected to the power source line VLED20, and the cathodes thereof are each connected to a corresponding one of the source lines S0, S1, and S2. The anodes of the three light-emitting elements 116a in the middle region 110z1 are connected to the power source line VLED21 and the cathodes thereof are each connected to a corresponding one of the source lines S0, S1, and S2. The anodes of the three light-emitting elements 116a in the lower region 110z2 are connected to the power source line VLED22 and the cathodes thereof are each connected to a corresponding one of the source lines S0, S1, and S2.

The lighting stop circuit 161 includes a resistor R20 and a switch SW21 connected in series between the power source line VLED and a ground line VSS, and a switch SW22 disposed between the power source lines VLED and VLED1. The switch SW22 is an example of a second switch. For example, the switch SW21 is an n-channel metal oxide semiconductor (MOS) transistor, and the switch SW22 is a p-channel MOS transistor.

The switch SW21 is turned on when receiving a high-level cutoff signal OFF at its gate, and supplies a low-level signal to the gate of the switch SW22 to turn on the switch SW22. When the switch SW22 is turned on, the power source line VLED is connected to the power source line VLED1. The switch SW21 is turned off when receiving a low-level cutoff signal OFF at its gate. During a period in which the switch SW21 is turned off, a high-level signal is supplied to the gate of the switch SW22 from the power source line VLED via the resistor R20, and the switch SW22 is turned off. When the switch SW22 is turned off, the power source line VLED1 is brought into a floating state.

The lighting circuit 162 includes resistors R100, R101, R110, R111, R120, and R121, and switches SW10, SW11, and SW12, each of which supplies a current to the planar light source 111. The switches SW10, SW11, and SW12 are examples of a first switch.

For example, the switches SW10, SW11, and SW12 are p-channel MOS transistors. The switch SW10 is disposed between the power source line VLED1 and the power source line VLED20. The switch SW11 is disposed between the power source line VLED1 and the power source line VLED21. The switch SW12 is disposed between the power source line VLED1 and the power source line VLED22.

The resistors R100 and R101 are connected in series between the power source line VLED1 and the scan signal line Sync_VS0. The resistors R110 and R111 are connected in series between the power source line VLED1 and the scan signal line Sync_VS1. The resistors R120 and R121 are connected in series between the power source line VLED1 and the scan signal line Sync_VS2.

The gate of the switch SW10 is connected to the connection node between the resistors R100 and R101, is connected to the power source line VLED1 via the resistor R100, and is connected to the scan signal line Sync_VS0 via the resistor R101. The gate of the switch SW11 is connected to the connection node between the resistors R110 and R111, is connected to the power source line VLED1 via the resistor R110, and is connected to the scan signal line Sync_VS1 via the resistor R111. The gate of the switch SW12 is connected to the connection node between the resistors R120 and R121, is connected to the power source line VLED1 via the resistor R120, and is connected to the scan signal line Sync_VS2 via the resistor R121.

The switch SW10 is turned on when the cutoff signal OFF is set to a high level and the scan signal Sync_VS0 is set to a low level, and connects the anodes of the three light-emitting elements 116a in the upper region 110z0 to the power source line VLED. The switch SW11 is turned on when the cutoff signal OFF is set to a high level and the scan signal Sync_VS1 is set to a low level, and connects the anodes of the three light-emitting elements 116a in the middle region 110z1 to the power source line VLED. The switch SW12 is turned on when the cutoff signal OFF is set to a high level and the scan signal Sync_VS2 is set to a low level, and connects the anodes of the three light-emitting elements 116a in the lower region 110z2 to the power source line VLED.

When the source line S0, S1, or S2 connected to the cathode of the light-emitting element 116a is set to a low level (for example, the ground voltage VSS), the light-emitting element 116a whose anode is connected to the power source line VLED is turned on by causing a current to flow from the anode to the cathode. For example, in the present embodiment, each of the light-emitting elements 116a in the upper region 110z0, the middle region 110z1, and the lower region 110z2 is exclusively turned on when all the source lines S0 to S2 are set to the low level by a drive signal generation unit 151, and any one of the scan signals Sync_VSi is set to the low level.

On the other hand, when the scan signal Sync_VS0 is set to a high level, the switch SW10 is turned off regardless of the level of the cutoff signal OFF, and stops the supply of a current to the three light-emitting elements 116a in the upper region 110z0. When the scan signal Sync_VS1 is set to a high level, the switch SW11 is turned off regardless of the level of the cutoff signal OFF, and stops the supply of a current to the three light-emitting elements 116a in the middle region 110z1. When the scan signal Sync_VS2 is set to a high level, the switch SW12 is turned off regardless of the level of the cutoff signal OFF, and stops the supply of a current to the three light-emitting elements 116a in the lower region 110z2.

When the cutoff signal OFF is set to a low level, the power source line VLED1 connected to the sources of the switches SW10, SW11, and SW12 is in the floating state. As a result, the power source lines VLED20, VLED21, and VLED22 also come into the floating state, and the supply of a current to all the light-emitting elements 116a of the planar light source 111 is stopped. For this reason, when the cutoff signal OFF is set to the low level, the light-emitting elements 116a in the upper region 110z0, the middle region 110z1, and the lower region 110z2 are simultaneously turned off regardless of the levels of the scan signals Sync_VS0, Sync_VS1, and Sync_VS2.

The backlight driving circuit 150 includes the drive signal generation unit 151, a storage unit 152, and the cutoff control unit 153. The drive signal generation unit 151 generates the scan synchronization signal Sync_VS, which is a reference signal for operating the backlight device 110, asynchronously with respect to the vertical synchronization signal Vsync used for the operation of the liquid crystal panel 120.

In synchronization with the scan synchronization signal Sync_VS, the drive signal generation unit 151 performs scan driving for exclusively and sequentially setting the scan signals Sync_VS0, Sync_VS1, and Sync_VS2 to a low level within one cycle of the scan synchronization signal Sync_VS. Accordingly, when the cutoff signal OFF is set to a high level and the power source line VLED1 is set to the power source voltage VLED, the switches SW10, SW11, and SW12 of the lighting circuit 162 are sequentially turned on within one cycle of the scan synchronization signal Sync_VS.

The drive signal generation unit 151 performs control to connect the source lines S0 to S2 connected to the cathodes of the light-emitting elements 116a of the planar light source 111 to the low level line and control to disconnect the source lines S0 to S2 from the low level line. The drive signal generation unit 151 sequentially generates the scan signals Sync_VS0, Sync_VS1, and Sync_VS2 in synchronization with the scan synchronization signal Sync_VS, and connects or disconnects the source lines S0 to S2 to or from the low level line, thereby enabling the control of turning on and off for each of the light-emitting elements 116a. As described above, the voltage of the low level line may be 0 V or a voltage slightly higher than 0 V.

For example, the luminance of the light-emitting region 111s due to lighting of the light-emitting element 116a can be adjusted by changing the time (duty ratio) during which the corresponding source lines S0 to S2 are set to the low level for each ON period of the scan signals Sync_VS0, Sync_VS1, and Sync_VS2, and changing the amount of current flowing through the light-emitting elements 116a per unit time. For example, the drive signal generation unit 151 may change the low-level period per unit time of each of the source lines S0 to S2 by pulse width modulation (PWM) control. Accordingly, it is possible to perform the local dimming control for controlling a lighting period (that is, luminance) for every predetermined number of light-emitting elements 116a in accordance with an image displayed on the liquid crystal panel 120.

When the planar light source 111 includes the light-emitting regions 111s of N rows and M columns as illustrated in FIG. 2 and each of the three rectangular regions 110z of the planar light source 111 includes the light-emitting regions 111s of three rows as illustrated in FIG. 5, 16 source lines S0 to S15 (not illustrated) corresponding to the M columns are connected between the planar light source 111 and the backlight driving circuit 150. Each of the power source lines VLED20, VLED21, and VLED22 is connected to the anodes of the 48 light-emitting elements 116a in a corresponding one of the rectangular regions 110z.

The storage unit 152 includes a read only memory (ROM), a fuse, or the like that stores the period P and the time duration T. For example, the period P and the time duration T are written in the storage unit 152 when the backlight device 110 is manufactured or before the backlight device 110 is shipped.

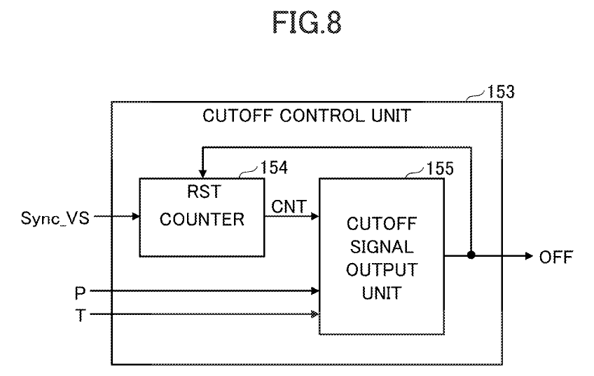

The cutoff control unit 153 generates the cutoff signal OFF having the output cycle indicated by the period P stored in the storage unit 152 and the output period indicated by the time duration T stored in the storage unit 152 in synchronization with the scan synchronization signal Sync_VS. An example of the circuit block of the cutoff control unit 153 is illustrated in FIG. 8, and examples of the waveform of the cutoff signal OFF are illustrated in FIGS. 9 and 10.

By generating the cutoff signal OFF in the backlight device 110, even when the backlight devices 110 of different types are mounted on the liquid crystal display device 100, the operation of reducing the flickering of images displayed with the planar light source 111 described with reference to FIG. 9 can be appropriately performed for each backlight device 110. In other words, the flickering can be reduced for each backlight device 110 without providing the function of reducing the flickering of images in the control circuit 140.

FIG. 8 is a circuit block diagram illustrating an example of the cutoff control unit 153 of FIG. 7. The cutoff control unit 153 includes a counter 154 and a cutoff signal output unit (e.g., cutoff signal output circuit) 155. The counter 154 performs a counting operation in synchronization with the scan synchronization signal Sync_VS and outputs the number of pulses of the scan synchronization signal Sync_VS as a counter value CNT. The counter 154 is reset when the rising edge of the cutoff signal OFF is received by a reset terminal RST, and initializes the counter value CNT to, for example, "0". The counter 154 is also initialized when the liquid crystal display device 100 or the backlight device 110 is activated.

When the counter value CNT from the counter 154 becomes a value obtained by subtracting the time duration T from the period P, the cutoff signal output unit 155 sets the cutoff signal OFF to the low level, which is the active level, only for the time duration T. The time duration T is indicated by the cycle of the scan synchronization signal Sync_VS.

For example, when the time duration T is "1", the cutoff signal output unit 155 sets the cutoff signal OFF to the low level, which is the active level, during one cycle of the scan synchronization signal Sync_VS, and when the time duration T is "2", sets the cutoff signal OFF to the low level during two cycles of the scan synchronization signal Sync_VS. The cutoff signal output unit 155 returns the cutoff signal OFF to the high level, which is the inactive level, after the elapse of the time duration T.

### Operation Timing of Liquid Crystal Display Device

FIG. 9 is a timing chart illustrating an example of operations of the liquid crystal display device 100 of FIG. 1. For example, the operations illustrated in FIG. 9 are achieved by implementing the method of controlling the backlight device 110. FIG. 9 illustrates an example in which a motion blur countermeasure is performed, and the period P is set to "3" and the time duration T is set to "1" for the flicker prevention countermeasure.

The liquid crystal driving circuit 130 illustrated in FIG. 6 displays an image on the liquid crystal panel 120 for each one frame period corresponding to the cycle of the vertical synchronization signal Vsync, which is a positive pulse signal. Then, for example, an image is displayed on the liquid crystal panel 120 in each of the frames 1 to 6. The drive signal generation unit 151 connects the source lines S0 to S2 of FIG. 7 to the low level line during at least a period in which an image is displayed on the liquid crystal panel 120 (a period of at least six frames in FIG. 9).

For the power source lines VLED1, VLED20, VLED21, and VLED22 illustrated in FIG. 9, a solid line indicates that a power source voltage is supplied, and a broken line indicates that the power source line is in a floating state. For the upper region 110z0, the middle region 110z1, and the lower region 110z2 illustrated in FIG. 9, rectangles indicate that the light-emitting elements 116a are turned on, and portions without rectangles indicate that the light-emitting elements 116a are turned off.

The drive signal generation unit 151 of FIG. 7 repeatedly generates the scan synchronization signal Sync_VS, which is a positive pulse signal, asynchronously with respect to the vertical synchronization signal Vsync. In the example illustrated in FIG. 9, the drive signal generation unit 151 generates the scan synchronization signal Sync_VS in a cycle shorter than the cycle of the vertical synchronization signal Vsync. The drive signal generation unit 151 sequentially generates the scan signals Sync_VS0, Sync_VS1, and Sync_VS2 having negative pulses within one cycle of the scan synchronization signal Sync_VS without the negative pulses overlapping each other.

While the counter value CNT is smaller than "period P - time duration T" ("0" or "1"), the cutoff control unit 153 outputs the cutoff signal OFF at the high level. When the counter value CNT reaches "period P - time duration T" (that is, "2"), the cutoff control unit 153 sets the cutoff signal OFF to the low level. The cutoff control unit 153 maintains the cutoff signal OFF at the low level for the number of cycles (= "1") of the scan synchronization signal Sync_VS indicated by the time duration T, and then returns the cutoff signal OFF to the high level. The counter 154 resets the counter value CNT to "0" in response to the change of the cutoff signal OFF to the high level.

The lighting stop circuit 161 turns on the switch SW22 and supplies the power source voltage VLED to the power source line VLED1 during a period in which the cutoff signal OFF is at the high level. The lighting stop circuit 161 turns off the switch SW22 and sets the power source line VLED1 to a floating state during a period in which the cutoff signal OFF is at the low level.

During a period in which the power source line VLED1 is connected to the power source line VLED, the lighting circuit 162 sequentially connects the power source line VLED1 to the power source lines VLED20, VLED21, and VLED22 during a respective low-level period of the scan signals Sync_VS0, Sync_VS1, and Sync_VS2. As a result, the power source lines VLED20, VLED21, and VLED22 are sequentially connected to the power source line VLED via the power source voltage VLED1, and the light-emitting elements 116a in the corresponding upper region 110z0, middle region 110z1, and lower region 110z2 are sequentially turned on.

The lighting circuit 162 sets the power source lines VLED20, VLED21, and VLED22 to the floating state regardless of the levels of the scan signals Sync_VS0, Sync_VS1, and Sync_VS2 during a period in which the cutoff signal OFF is set to the low level and the power source line VLED1 is in the floating state. Therefore, during a period in which the cutoff signal OFF is at the low level, all the light-emitting elements 116a of the planar light source 111 are turned off regardless of the levels of the scan signals Sync_VS0, Sync_VS1, and Sync_VS2.

The cutoff signal OFF and the scan signals Sync_VS0, Sync_VS1, and Sync_VS2 are generated in synchronization with the scan synchronization signal Sync_VS. The low-level period of the cutoff signal OFF coincides with the period of one cycle of the scan synchronization signal Sync_VS indicated by the time duration T. Therefore, the falling edge and the rising edge of the cutoff signal OFF do not appear in the low-level states (active states) of the scan signals Sync_VS0, Sync_VS1, and Sync_VS2.

Therefore, the lighting period of each of the light-emitting elements 116a can be prevented from being shortened due to the low level of the cutoff signal OFF, and the lighting periods of all the light-emitting elements 116a can be made uniform. In other words, it is possible to prevent the lighting period of each of the light-emitting elements 116a from becoming shorter than the low-level period of the scan signals Sync_VS0, Sync_VS1, and Sync_VS2. Since the lighting periods of the light-emitting elements 116a can be prevented from varying, flickering on each of the rectangular regions 110z can be reduced.

It is noted that when the cutoff signal OFF is fixed to the high level, for example, one or both of the period P and the time duration T are set to "0". When the cutoff signal OFF is fixed to the high level, the scan signals Sync_VS0, Sync_VS1, and Sync_VS2 are exclusively sequentially set to the low level, and the light-emitting elements 116a of the corresponding upper region 110z0, middle region 110z1, and lower region 110z2 are exclusively sequentially turned on without being simultaneously turned off.

FIG. 10 is a timing chart illustrating another example of the operations of the liquid crystal display device 100 of FIG. 1. Detailed description of the same operation as that in FIG. 9 is omitted. For example, the operation illustrated in FIG. 10 is performed by implementing the control method of the backlight device 110. FIG. 10 illustrates an example in which the motion blur countermeasure is performed, and the period P is set to "5" and the time duration T is set to "2" for the flicker prevention countermeasure. The number of frames, and the waveforms of the vertical synchronization signal Vsync, the scan synchronization signal Sync_VS, and the scan signals Sync_VS0, Sync_VS1, and Sync_VS2 are the same as those in FIG. 9.

In the same manner as in FIG. 9, the drive signal generation unit 151 sequentially generates the scan signals Sync_VS0, Sync_VS1, and Sync_VS2 within one cycle of the scan synchronization signal Sync_VS without the negative pulses overlapping each other. In addition, the drive signal generation unit 151 connects the source lines S0 to S2 of FIG. 7 to the low level line during at least a period in which an image is displayed on the liquid crystal panel 120.

While the counter value CNT is smaller than "period P - time duration T" ("0", "1", or "2"), the cutoff control unit 153 outputs the cutoff signal OFF at the high level. When the counter value CNT reaches "period P - time duration T" (i.e., "3"), the cutoff control unit 153 sets the cutoff signal OFF to the low level. The cutoff control unit 153 maintains the cutoff signal OFF at the low level for the number of cycles (= "2") of the scan synchronization signal Sync_VS indicated by the time duration T, and then returns the cutoff signal OFF to the high level. The counter 154 resets the counter value CNT to "0" in response to the change of the cutoff signal OFF to the high level.

The lighting stop circuit 161 turns on the switch SW22 and supplies the power source voltage VLED to the power source line VLED1 during a period in which the cutoff signal OFF is at the high level. The lighting stop circuit 161 turns off the switch SW22 and sets the power source line VLED1 to a floating state during a period in which the cutoff signal OFF is at the low level.

As described above, in the same manner as in FIG. 9, the scan signals Sync_VS0, Sync_VS1, and Sync_VS2 are sequentially set to the low level during the period in which the cutoff signal OFF is at the high level. A current sequentially flows through the light-emitting elements 116a of the upper region 110z0, the middle region 110z1, and the lower region 110z2 respectively corresponding to the scan signals Sync_VS0, Sync_VS1, and Sync_VS2, so that the light-emitting elements 116a are sequentially turned on. In addition, during a period in which the cutoff signal OFF is at the low level, all the light-emitting elements 116a of the planar light source 111 are turned off regardless of the levels of the scan signals Sync_VS0, Sync_VS1, and Sync_VS2.

Also in FIG. 10, the falling edge and the rising edge of the cutoff signal OFF do not appear in the low-level states (active states) of the scan signals Sync_VS0, Sync_VS1, and Sync_VS2. Therefore, the lighting period of the light-emitting elements 116a can be prevented from being shortened due to the low level of the cutoff signal OFF, and the lighting periods of all the light-emitting elements 116a can be made uniform. Since the lighting period can be prevented from varying, flickering of each of the rectangular regions 110z can be reduced.

### Current Flowing through Light-Emitting Elements during Scan Driving

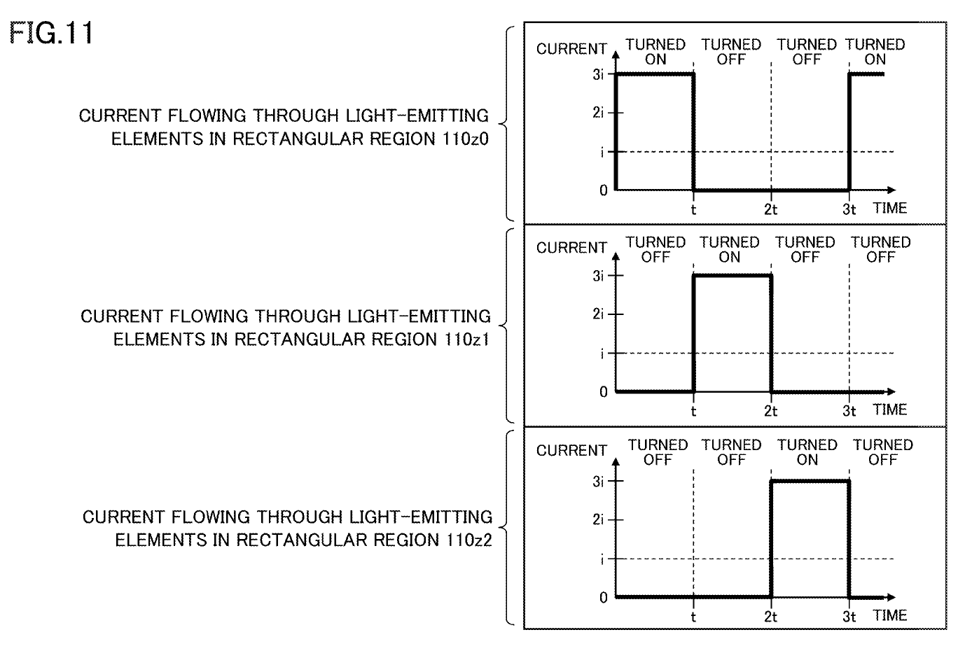

FIG. 11 is a waveform diagram illustrating an example of a current flowing through the light-emitting elements 116a when each of the rectangular regions 110z0, 110z1, 110z2 of the planar light source 111 of FIG. 6 is scan-driven. In the scan driving, the light-emitting element 116a to be turned on is selected by a combination of the anode connected to the power source line VLED and the cathode connected to the low level line. Then, the light-emitting element 116a whose anode is connected to the power source line VLED and whose cathode is connected to the low level line is turned on.

In the scan driving illustrated in FIGS. 9 and 10, the light-emitting elements 116a of the plurality of rectangular regions 110z of the planar light source 111 are sequentially selected by the corresponding scan signals Sync_VSi, and a current flows through the light-emitting elements 116a. Thus, the light-emitting elements 116a in the rectangular regions 110z are periodically and repeatedly turned on and off without the lighting periods overlapping each other. The number of rectangular regions 110z is also referred to as the number of scans.

Here, since the light-emitting elements 116a are blinked at a high speed (for example, equal to or higher than 480 Hz), human eyes perceive the light-emitting elements 116a in the rectangular region 110z as if they are always turned on. Actually, the lighting period of the light-emitting elements 116a in the rectangular region 110z is one third of the cycle of the scan synchronization signal Sync_VS.

Therefore, the average luminance of the light emitted from the light-emitting region 111s is one third of the luminance in the case of direct current (DC) driving in which a constant direct current is supplied to all the light-emitting elements 116a to always turn on the light-emitting elements 116a. That is, the average luminance is "1/(number of scans) ". In order to make the luminance at the time of scan-driving the same as the luminance at the time of DC driving, it is necessary to supply a current multiplied by about the number of scans to the light-emitting elements 116a. For example, when the current at the time of DC driving is "i" and the planar light source 111 is divided into three rectangular regions 110z (the number of scans = "3"), it is necessary to supply a current of "3i" to each of the light-emitting elements 116a.

### Operation Timing Example of Causing Flickering of Planar Light Source

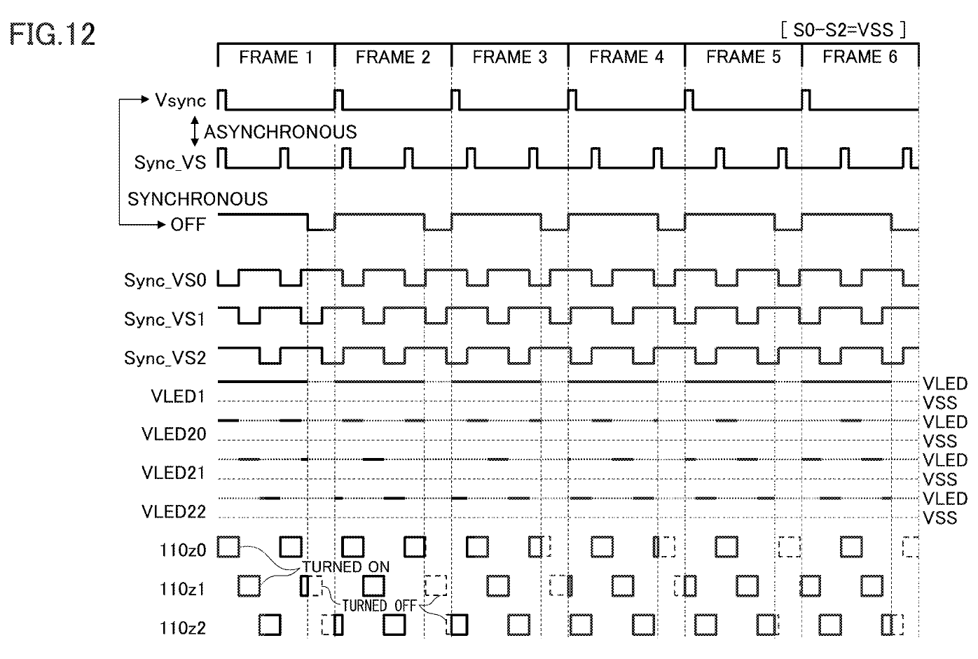

FIG. 12 is a timing chart illustrating a comparative example of operations of the liquid crystal display device in which the scan synchronization signal Sync_VS is generated asynchronously with the vertical synchronization signal Vsync and the cutoff signal OFF is generated synchronously with the vertical synchronization signal Vsync. Detailed description of the same operation as that in FIG. 9 is omitted. In the upper region 110z0, the middle region 110z1, and the lower region 110z2, the broken-line rectangles indicate that the supply of a current to the light-emitting elements 116a is cut off by the cutoff signal OFF at the low level and the light-emitting elements 116a are turned off even though the scan signal Sync_VS0, Sync_VS1, or Sync_VS2 is at the low level.

When the cutoff signal OFF is not synchronized with the scan synchronization signal Sync_VS, the falling edge and the rising edge of the cutoff signal OFF appear in the low-level state (active state) of the scan signals Sync_VS0, Sync_VS1, and Sync_VS2. For this reason, the lighting periods and the turn-off periods of the rectangular regions 110z of the planar light source 111 vary, which causes the planar light source 111 of the backlight device 110 to appear to flicker.

### Second Embodiment

### Block Diagram of Liquid Crystal Display Device

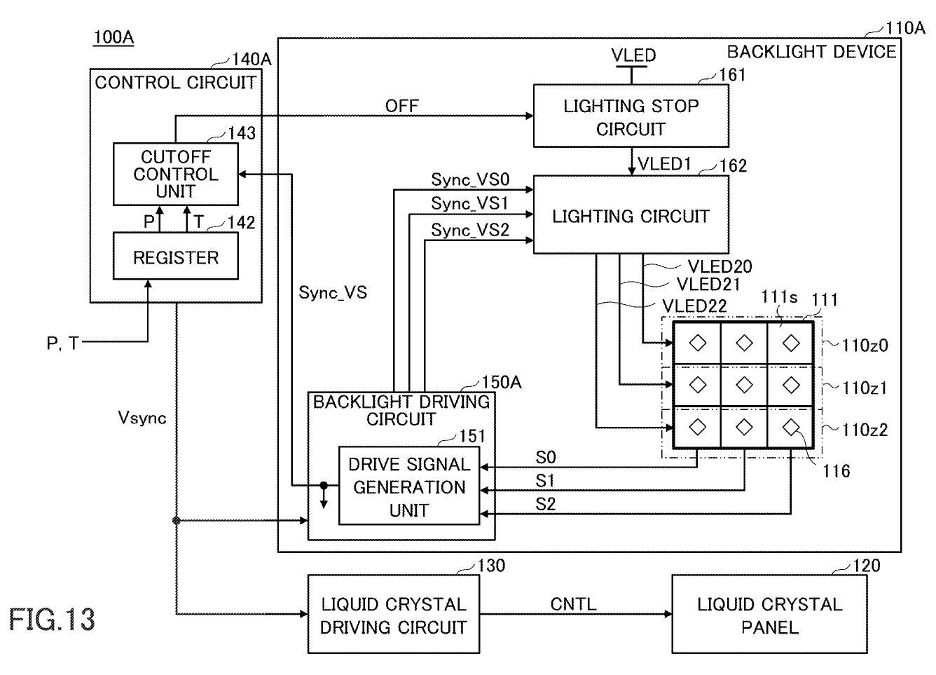

FIG. 13 is a block diagram illustrating an example of a liquid crystal display device according to a second embodiment. The same elements as those in FIG. 6 are denoted by the same reference characters, and a detailed description thereof is omitted. The outline of the structure of a liquid crystal display device 100A illustrated in FIG. 13 is the same as that illustrated in FIG. 1. The structure of the planar light source 111 is similar to that illustrated in FIGS. 2 and 3, or similar to that illustrated in FIGS. 4A and 4B. The allocation of the rectangular regions 110z of the planar light source 111 is the same as that in FIG. 5.

The liquid crystal display device 100A includes a backlight device 110A, the liquid crystal panel 120, the liquid crystal driving circuit 130, and a control circuit 140A. The backlight device 110A includes the planar light source 111, the lighting stop circuit 161, the lighting circuit 162, and a backlight driving circuit 150A.

The backlight driving circuit 150A includes the drive signal generation unit 151 that generates the scan synchronization signal Sync_VS, but does not include the storage unit 152 and the cutoff control unit 153 illustrated in FIG. 7. The backlight driving circuit 150A has the same function as that of the backlight driving circuit 150 of FIG. 7 except that the backlight driving circuit 150A does not include the storage unit 152 and the cutoff control unit 153 that outputs the cutoff signal OFF.

The control circuit 140A includes a register 142 and a cutoff control unit 143. The register 142 stores the period P and the time duration T in a changeable manner. For example, the setting of the period P and the time duration T in the cutoff control unit 143 is performed by initialization processing at the time of activation of the liquid crystal display device 100A. Thus, for example, by changing the firmware of the liquid crystal display device 100A after the control circuit 140A is designed or the liquid crystal display device 100A is shipped, the period P and the time duration T can be reset, and the waveform of the cutoff signal OFF can be changed.

The period P and the time duration T may be set in accordance with electrical specifications such as voltage conditions of the backlight device 110A mounted on the liquid crystal display device 100A, the frequencies of the scan signals Sync_VSi, and the like. Thus, the light-emitting elements 116a can be appropriately turned on in accordance with the backlight device 110A mounted on the liquid crystal display device 100A.

It is noted that the period P and the time duration T may be set in the storage unit 152 by the control circuit 140 in accordance with an operation mode of the liquid crystal display device 100 set by a user or the like. In addition, the period P and the time duration T may be set in the storage unit 152 in response to an instruction from a user who views the screen of the liquid crystal display device 100. Further, the period P and the time duration T may be set to fixed values for each liquid crystal display device 100.

The configuration of the cutoff control unit 143 is the same as the configuration of the cutoff control unit 153 in FIG. 8. The cutoff control unit 143 receives the scan synchronization signal Sync_VS from the drive signal generation unit 151 of the backlight driving circuit 150A, and generates the cutoff signal OFF based on the period P and the time duration T stored in the register 142. The cutoff control unit 143 outputs the generated cutoff signal OFF to the lighting stop circuit 161. The operation of the liquid crystal display device 100A is the same as the operations illustrated in FIGS. 9 to 11 except that the cutoff signal OFF is generated by the control circuit 140A.

Certain embodiments and the like have been described in detail above.

However, the disclosure is not limited to the above-described embodiments and the like, and various modifications and substitutions can be made to the above-described embodiments and the like without departing from the scope described in the claims.

WHAT IS CLAIMED IS:

1. A backlight device configured to be disposed under a liquid crystal panel, the backlight device comprising:
a plurality of light-emitting units, each of the light-emitting unit comprising one or more light sources;
a backlight driving circuit configured to generate a scan synchronization signal that is asynchronous to a vertical synchronization signal generated for each frame cycle of the liquid crystal panel, and generate a plurality of scan signals to sequentially turn on the plurality of light-emitting units in synchronization with the generated scan synchronization signal; and
a lighting stop circuit configured to stop lighting of the plurality of light- emitting units during one or more cycles of the scan synchronization signal.

2. The backlight device according to claim 1, further comprising:
a plurality of first switches disposed between a current source and the plurality of light-emitting units, respectively, each of the plurality of first switches being configured to be turned on during an active state of a corresponding one of the scan signals generated by the backlight driving circuit in each cycle of the scan synchronization signal, wherein
the active states of the plurality of scan signals do not overlap each other, and
the lighting stop circuit comprises a second switch disposed between the current source and the plurality of first switches and configured to be turned off during the one or more cycles of the scan synchronization signal.

3. The backlight device according to claim 1, further comprising a luminance adjustment circuit configured to adjust luminance of each of the plurality of light- emitting units in synchronization with the vertical synchronization signal.

4. The backlight device according to claim 1, wherein
each of the plurality of light-emitting units comprises a plurality of the light sources, and
the plurality of light sources of the plurality of light-emitting units are two- dimensionally arranged.

5. The backlight device according to claim 1, wherein the lighting stop circuit is configured to stop lighting of the plurality of light-emitting units during a first number of cycles of the scan synchronization signal periodically in each period consisting of a second number of cycles of the scan synchronization signal, the first number being equal to or greater than one and less than the second number.

6. The backlight device according to claim 5, wherein the first number of cycles is two or more cycles, which are consecutive.

7. The backlight device according to claim 5, wherein the first number is less than a half of the second number.

8. The backlight device according to claim 5, wherein a duration of the first number of cycles of the scan synchronization signal is shorter than the frame cycle of the liquid crystal display.

9. The backlight device according to claim 5, wherein a duration of the first number of cycles of the scan synchronization signal is longer than the frame cycle of the liquid crystal display.

10. The backlight device according to claim 5, wherein the backlight driving circuit includes a memory that stores the first number and the second number.

11. The backlight device according to claim 1, further comprising:
a counter configured to count the cycle of the scan synchronization signal; and
a cutoff signal output circuit configured to output a cutoff signal to the lighting stop circuit during the one or more cycles of the scan synchronization signal each time the counter counts a predetermined number,
wherein the lighting stop circuit stops lighting of the plurality of light-emitting units while receiving the cutoff signal from the cutoff signal output circuit.

12. The backlight device according to claim 1, wherein the cycle of the scan synchronization signal is shorter than the frame cycle of the liquid crystal display.

13. The backlight device according to claim 1, wherein the plurality of light- emitting units comprises three or more light-emitting units vertically arranged, and each of the three or more light-emitting units includes an array of light sources that are arranged vertically and horizontally.

14. A liquid crystal display device comprising:
the backlight device according to claim 1; and
a liquid crystal panel disposed on the backlight device.

15. A liquid crystal display device comprising:
the backlight device according to claim 1;
a liquid crystal panel disposed on the backlight device;
a liquid crystal driving circuit configured to drive the liquid crystal panel; and
a control circuit configured to generate the vertical synchronization signal, which is output to the liquid crystal driving circuit and the backlight driving circuit, and receive the scan synchronization signal from the backlight driving circuit,
wherein the control circuit comprises:
a counter configured to count pulses of the scan synchronization signal; and
a cutoff signal output circuit configured to output a cutoff signal to the lighting stop circuit during the one or more cycles of the scan synchronization signal each time the counter counts a predetermined number, and
the lighting stop circuit stops lighting of the plurality of light-emitting units while receiving the cutoff signal from the cutoff signal output circuit.

16. The liquid crystal display device according to claim 15, wherein the control circuit is configured to change, based on an input from outside, the predetermined number to be counted by the counter and the number of the one or more cycles of the scan synchronization signal during which the cutoff signal is outputted.

17. A method for controlling a backlight device disposed under a liquid crystal panel and comprising a plurality of light-emitting units, each of the plurality of light- emitting units comprising one or more light sources, the method comprising:
generating a scan synchronization signal that is asynchronous to a vertical synchronization signal generated for each frame cycle of the liquid crystal panel;
generating a plurality of scan signals to sequentially turning on the plurality of light-emitting units in synchronization with the generated scan synchronization signal;
and
stopping lighting of the plurality of light-emitting units during one or more cycles of the scan synchronization signal.

18. The method according to claim 17, wherein said stopping lighting comprises stopping lighting of the plurality of light-emitting units during a first number of cycles of the scan synchronization signal periodically in each period consisting of a second number of cycles of the scan synchronization signal, the first number being equal to or greater than one and less than the second number.

19. The method according to claim 18, wherein the first number of cycles is two or more cycles, which are consecutive.

20. The method according to claim 18, wherein the first number is less than a half of the second number.
